(19) United States
(12) Patent Application Publication
(10) Pub. No.: US 2025/0293866 A1
(43) Pub. Date: Sep. 18, 2025

(54) QUANTUM KEY DISTRIBUTION SYSTEM, KEY MANAGEMENT APPARATUS, AND KEY MANAGEMENT METHOD

(71) Applicant: NEC Corporation, Tokyo (JP)

(72) Inventor: Hiroyuki TOYAMA, Tokyo (JP)

(73) Assignee: NEC Corporation, Tokyo (JP)

(21) Appl. No.: 19/053,497

(22) Filed: Feb. 14, 2025

(30) Foreign Application Priority Data
Mar. 18, 2024 (JP) 2024-042235

(51) Int. Cl. H04L 9/08

(52) U.S. Cl. CPC H04L 9/0855

(57) ABSTRACT

In a quantum key distribution system according to the present disclosure, each key management apparatus includes: a storage unit; a monitoring unit configured to monitor whether or not the QKDN management apparatus is in operation; and a registration control unit configured to, in a case where the monitoring unit determines that an operation of the QKDN management apparatus is stopped, store in the storage unit the cryptographic key before information indicating that the cryptographic key has been generated by the key generation apparatus managed by the key management apparatus is registered in the QKDN management apparatus as the life cycle information, and in a case where the monitoring unit determines that an operation of the QKDN management apparatus is started, register in the QKDN management apparatus the life cycle information about the cryptographic key stored in the storage unit.

### INCORPORATION BY REFERENCE

This application is based upon and claims the benefit of priority from Japanese patent application No. 2024-042235, filed on Mar. 18, 2024, the disclosure of which is incorporated herein in its entirety by reference.

### TECHNICAL FIELD

The present disclosure relates to a quantum key distribution system, a key management apparatus, and a key management method.

### BACKGROUND ART

In a cryptographic communication of a message from a transmission server to a reception server, the encryption of the message in the transmission server and the decryption of the message in the reception server are performed using a cryptographic key shared in advance by the transmission server and the reception server. In particular, the cryptographic communication in which a new cryptographic key is generated for each communication of a message is referred to as a cryptographic communication of a one-time pad scheme.

Further, in recent years, quantum cryptographic communication has been developed. The quantum cryptographic communication is a kind of a cryptographic communication of a one-time pad scheme, in which a cryptographic key generated by a transmitter on the transmission server side is superimposed on photons (light particles) which are the smallest units of light or a weak light and delivered from the transmitter to a receiver on the reception server side, whereby more secure cryptographic communication is enabled. A technology related to the quantum cryptographic communication is disclosed in, for example, Patent Literature 1.

Patent Literature 1 discloses a quantum key distribution network apparatus for independently operating a data transfer path and a quantum key consumption path on which a quantum key is consumed to encrypt corresponding data in a quantum key distribution network.
[Patent Literature 1] Japanese Unexamined Patent Application Publication No. 2023-175604

### SUMMARY

In the quantum cryptographic communication, it is required to efficiently use a cryptographic key generated by a key generation apparatus provided in each base of a quantum key distribution network.

One of the objects of the present disclosure is to provide a quantum key distribution system, a key management apparatus, a key management method, and a control program that solve the above-described problem.

A quantum key distribution system according to one example aspect of the present disclosure includes: a plurality of key generation apparatuses configured to generate cryptographic keys, the plurality of key generation apparatuses being respectively provided in a plurality of bases and connected to each other through optical fibers; a plurality of key management apparatuses provided so as to respectively correspond to the plurality of key generation apparatuses, the plurality of key management apparatuses being configured to manage the cryptographic keys respectively generated by the plurality of key generation apparatuses; a plurality of key supply apparatuses provided so as to respectively correspond to the plurality of key management apparatuses, the plurality of key supply apparatuses being configured to supply the cryptographic keys managed by the plurality of key management apparatuses to an application in which quantum cryptographic communication is performed; and a QKDN management apparatus configured to acquire, as life cycle information, a cryptographic key processing status of each of the plurality of key generation apparatuses, the plurality of key management apparatuses, and the plurality of key supply apparatuses and manage the acquired statuses, in which each of the key management apparatuses includes: a storage unit; a monitoring unit configured to monitor whether or not the QKDN management apparatus is in operation; and a registration control unit configured to, in a case where the monitoring unit determines that an operation of the QKDN management apparatus is stopped, store in the storage unit the cryptographic key before information indicating that the cryptographic key has been generated by the key generation apparatus managed by the key management apparatus is registered in the QKDN management apparatus as the life cycle information, and in a case where the monitoring unit determines that an operation of the QKDN management apparatus is started, register in the QKDN management apparatus the life cycle information about the cryptographic key stored in the storage unit.

A key management apparatus according to one example aspect of the present disclosure is a key management apparatus configured to manage a cryptographic key generated by a key generation apparatus connected to another key generation apparatus through an optical fiber, the key management apparatus including: a storage unit; a monitoring unit configured to monitor whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information; and a registration control unit configured to, in a case where the monitoring unit determines that an operation of the QKDN management apparatus is stopped, store in the storage unit the cryptographic key before information indicating that the cryptographic key has been generated by the key generation apparatus managed by the key management apparatus is registered in the QKDN management apparatus as the life cycle information, and in a case where the monitoring unit determines that an operation of the QKDN management apparatus is started, register in the QKDN management apparatus the life cycle information about the cryptographic key stored in the storage unit.

A key management method according to one example aspect of the present disclosure is a key management method for a key management apparatus configured to manage a cryptographic key generated by a key generation apparatus connected to another key generation apparatus through an optical fiber, the key management method including: monitoring whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information; in a case where it is determined that an operation of the QKDN management apparatus is stopped, storing in a storage unit the cryptographic key before information indicating that the cryptographic key has been generated by the key generation apparatus managed by the key management apparatus is registered in the QKDN management apparatus as the life cycle information; and in a case where it is determined that an operation of the QKDN management apparatus is started, registering in the QKDN management apparatus the life cycle information about the cryptographic key stored in the storage unit.

A control program according to one example aspect of the present disclosure is a control program for causing a computer to execute key management processing performed by a key management apparatus configured to manage a cryptographic key generated by a key generation apparatus connected to another key generation apparatus through an optical fiber, the key management processing including: monitoring whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information; in a case where it is determined that an operation of the QKDN management apparatus is stopped, storing in a storage unit the cryptographic key before information indicating that the cryptographic key has been generated by the key generation apparatus managed by the key management apparatus is registered in the QKDN management apparatus as the life cycle information; and in a case where it is determined that an operation of the QKDN management apparatus is started, registering in the QKDN management apparatus the life cycle information about the cryptographic key stored in the storage unit.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram showing an example of a configuration of a quantum key distribution system according to the present disclosure;

FIG. 2 is a diagram showing a relationship among a transmission distance, a key generation probability, and a key generation rate in a quantum key distribution;

FIG. 3 is a block diagram showing an example of a configuration of a key management apparatus provided in the quantum key distribution system according to the present disclosure;

FIG. 4 is a flowchart showing operations performed by the key management apparatus provided in the quantum key distribution system according to the present disclosure;

FIG. 5 is a sequence diagram showing an example of operations performed by the quantum key distribution system according to the present disclosure;

FIG. 6 is a sequence diagram showing another example of operations performed by the quantum key distribution system according to the present disclosure;

FIG. 7 is a sequence diagram showing another example of operations performed by the quantum key distribution system according to the present disclosure; and

FIG. 8 is a block diagram showing an example of a hardware configuration for implementing a key management function of the key management apparatus according to the present disclosure.

### EXAMPLE EMBODIMENT

Example embodiments will be described hereinafter with reference to the drawings. Note that since the drawings are drawn in a simplified manner, the technical scope of the example embodiments should not be narrowly interpreted based on the descriptions of the drawings. Further, the same elements are denoted by the same reference symbols, and redundant descriptions will be omitted.

In the following example embodiments, as necessary, the present disclosure is explained by using separate sections or separate example embodiments. However, those example embodiments are not unrelated with each other, unless otherwise specified. That is, they are related in such a manner that one example embodiment is a modified example, an application example, a detailed explanation, or a supplementary explanation of a part or the whole of another example embodiment. Further, in the following example embodiments, in a case where the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may also be used.

Further, in the following example embodiments, their components (including operation steps and the like) are not necessarily essential except for cases where the component is explicitly specified or the component is obviously essential based on its principle. Similarly, in the following example embodiments, in a case where a shape, a position relation, or the like of a component(s) or the like is mentioned, shapes or the likes that are substantially similar to or resemble that shape are also included in that shape except for cases where it is explicitly specified or they are eliminated based on its principle. This is also true for the above-described number or the like (including numbers, values, quantities, ranges, and the like).

### First Example Embodiment

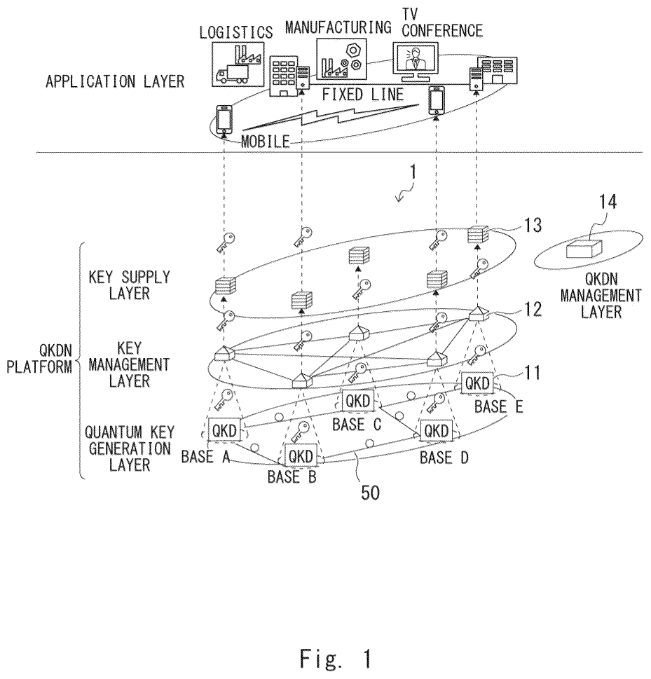

FIG. 1 is a diagram showing an example of a configuration of a quantum key distribution system according to the present disclosure. As shown in FIG. 1, a quantum key distribution system 1, which is a system that manages and operates cryptographic keys used for quantum cryptographic communications on a Quantum Key Distribution Network (QKDN) platform, includes at least a plurality of key generation apparatuses (QKD apparatuses) 11, a plurality of key management apparatuses 12, a plurality of key supply apparatuses 13, and a QKDN management apparatus 14.

Each of the plurality of key generation apparatuses 11 generates a cryptographic key. The plurality of key generation apparatuses 11 are provided at bases different from each other and connected to each other through optical fibers 50.

The quantum key distribution system 1, for example, is used for quantum cryptographic communication of a quantum key distribution scheme referred to as CV-QKD. In a cryptographic communication of a message from a transmission server to a reception server in an application layer, the encryption of the message in the transmission server and the decryption of the message in the reception server are performed using a cryptographic key shared in advance by the transmission server and the reception server. In particular, the cryptographic communication in which a new cryptographic key is generated for each communication of a message is referred to as a cryptographic communication of a one-time pad scheme.

The quantum cryptographic communication is a kind of a cryptographic communication of a one-time pad scheme, and the quantum key distribution system 1 superimposes a cryptographic key generated by the key generation apparatus 11 (a transmitter 11_1) provided so as to correspond to the transmitting server on weak light and delivers it from the transmitter to the key generation apparatus 11 (a receiver 11_2) provided so as to correspond to the reception server, thereby enabling a more secure cryptographic communication. Note that the weak light is, for example, light (quantum light) by which a quantum mechanical state change can be detected by setting a typical intensity of the light to be about one photon.

The transmitter 11_1 (the key generation apparatus 11 on the transmitting side) transmits, to the receiver 11_2 (the key generation apparatus 11 on the receiving side) through the optical fiber 50, a plurality of weak lights including information about a transmission bit and a transmission base randomly assigned. In other words, the transmitter 11_1 modulates the phase of each of the plurality of weak lights by using a transmission bit and a transmission base randomly assigned, and transmits them to the receiver 11_2 through the optical fiber 50.

For example, in a case where a bit value of the transmission bit is “0”, the amount of phase modulation of 0 degrees is assigned, while in a case where a bit value of the transmission bit is “1”, the amount of phase modulation of 180 degrees is assigned. Further, in a case where a base value of the transmission base is “X”, the amount of phase modulation of 0 degrees is assigned, while in a case where a base value of the transmission base is “Y”, the amount of phase modulation of 90 degrees is assigned. The phase of each of the weak lights is modulated by an amount of phase modulation obtained by adding the amount of phase modulation corresponding to the bit value and the amount of phase modulation corresponding to the base value. Therefore, a weak light the phase of which has been modulated using the transmission base having a base value of “X” ideally appears on a real axis, and a weak light the phase of which has been modulated using the transmission base having a base value of “Y” ideally appears on an imaginary axis.

The receiver 11_2 modulates a phase of a reference light by using a reception base randomly assigned so as to correspond to a transmission base that is randomly assigned to each of a plurality of received weak lights. Then, the receiver 11_2 performs base matching for a plurality of received weak lights by using, for example, a homodyne detector. Specifically, the receiver 11_2 causes a plurality of weak lights to be interfered with by a reference light the phase of which has been modulated, thereby detecting information (bit information) of a plurality of bit values from each of the plurality of weak lights interfered with by a reference light in which the base value of the reception base matches that of the transmission base. Note that the bit information includes a phase component representing a bit value, an amplitude component representing intensity of the bit value, and the like.

For example, in a case where a base value of the reception base is “X”, the amount of phase modulation of 0 degrees is assigned, while in a case where a base value of the reception base is “Y”, the amount of phase modulation of 90 degrees is assigned. Therefore, a desired bit information can be detected only in a case where weak and reference lights, in which transmission and reception bases thereof match each other, interfere with each other.

Then, in the transmitter 11_1 and the receiver 11_2, error correction processing is performed and then confidentiality enhancement processing is performed on the bit strings on which the error correction has been performed, and as a result, cryptographic keys (i.e., shared cryptographic keys) the bit strings of which match each other are individually generated.

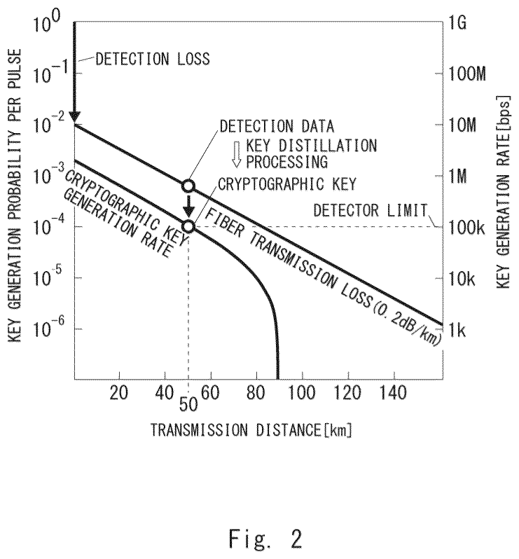

FIG. 2 is a diagram showing a relationship among a transmission distance, a key generation probability, and a key generation rate in a quantum key distribution. As shown in FIG. 2, as the transmission distance increases, the key generation rate decreases and the key generation probability decreases. In particular, in a case where the transmission distance exceeds 50 km, the key generation rate steeply decreases. Therefore, the length of each of the optical fibers 50 connecting a plurality of key generation apparatuses 11 to each other is, for example, equal to or smaller than 50 km.

Note that, in a case where quantum cryptographic communication is performed between two bases separated from each other by a long distance of more than 50 km, or in a case where quantum cryptographic communication is performed so as to avoid a transmission path where eavesdropping etc. may occur, quantum cryptographic communication (sharing of the cryptographic key) is performed via a base (relay location) different from the two bases. A key relay technology is used to share a cryptographic key between two bases via a relay base.

For example, in a case where a cryptographic key is shared between bases A and B via a relay base C, the key generation apparatus 11 of the base A first generates a cryptographic key Kab to be shared with the base B. Then, the key generation apparatus 11 at the base A and the key generation apparatus 11 at the relay base C generate respective cryptographic keys Kac that are the same as each other by the quantum key distribution technology described above. Then, the key Kab generated at the base A is encrypted by the cryptographic key Kac and transferred from the base A to the relay base C. In the relay base C, the encrypted key Kab is decrypted by the cryptographic key Kac. Then, the key generation apparatus 11 at the relay base C and the key generation apparatus 11 at the base B generate respective cryptographic keys Kcb that are the same as each other by the above-described quantum key distribution technology. Then, the key Kac decrypted at the relay base C is encrypted by the cryptographic key Kcb and transferred from the relay base C to the base B. At the base B, the encrypted key Kab is decrypted by the cryptographic key Kcb. In this way, by using a key relay technology, the cryptographic keys are shared between the bases A and B via the base C.

The plurality of key management apparatuses 12 are provided so as to respectively correspond to the plurality of key generation apparatuses 11, and manage cryptographic keys respectively generated by the plurality of key generation apparatuses 11. For example, each of the key management apparatuses 12 stores the cryptographic key generated by the corresponding key generation apparatus 11 in a storage unit, and manages the consumption of the cryptographic key by the key supply apparatus described later. Further, each of the key management apparatuses 12 encrypts and decrypts the cryptographic key (corresponding to the cryptographic key Kab described above) shared between the two bases by a key relay. The functions of each of the key management apparatuses 12 other than the above one will be described later.

The plurality of key supply apparatuses 13 are provided so as to respectively correspond to the plurality of key management apparatuses 12, and supply the cryptographic keys managed by the plurality of key management apparatuses 12 to an application in which quantum cryptographic communication is performed.

The QKDN management apparatus 14 acquires, as life cycle information, a cryptographic key processing status of each of the plurality of key generation apparatuses 11, the plurality of key management apparatuses 12, and the plurality of key supply apparatuses 13 and centrally manages them.

For example, in a case where a cryptographic key is generated by the key generation apparatus 11, the QKDN management apparatus 14 receives a registration application from the key management apparatus 12 that manages the key generation apparatus 11, and registers information indicating that a cryptographic key has been generated by the key generation apparatus 11 as life cycle information about the cryptographic key. Note that the life cycle information about the cryptographic key at this time includes the time at which the cryptographic key was generated, identification information of the key generation apparatus 11 that generated the cryptographic key, identification information of the cryptographic key (e.g., a combination of identification information of the key management apparatus 12 and a sequence number), and the like.

Further, for example, in a case where a cryptographic key is supplied to an application by the key supply apparatus 13, the QKDN management apparatus 14 receives a registration application from the key management apparatus 12 that manages the key supply apparatus 13, and registers information indicating that a cryptographic key has been supplied to (consumed for) an application by the key supply apparatus 13 as life cycle information about the cryptographic key. Note that the life cycle information about the cryptographic key at this time includes the time at which the cryptographic key was consumed, identification information of the key supply apparatus 13 that consumed the cryptographic key, identification information of the cryptographic key (e.g., a combination of identification information of the key management apparatus 12 and a sequence number), and the like.

### (Details of the Key Management Apparatus 12)

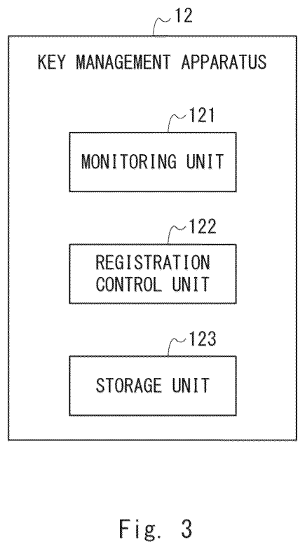

FIG. 3 is a block diagram showing an example of a configuration of the key management apparatus according to the present disclosure. As shown in FIG. 3, the key management apparatus 12 includes at least a monitoring unit 121, a registration control unit 122, and a storage unit 123.

The monitoring unit 121 monitors whether or not the QKDN management apparatus 14 is in operation. The registration control unit 122 controls registration of life cycle information about a cryptographic key in the QKDN management apparatus 14 based on a result of the monitoring of the QKDN management apparatus 14 by the monitoring unit 121.

For example, the monitoring unit 121 monitors whether or not the QKDN management apparatus 14 is in operation from a processing status of the QKDN management apparatus 14.

Alternatively, the monitoring unit 121 may monitor whether or not the QKDN management apparatus 14 is in operation from a response status of the QKDN management apparatus 14. Specifically, the monitoring unit 121 periodically monitors whether or not the QKDN management apparatus 14 is in operation based on whether or not the QKDN management apparatus 14 responds to a periodic application for registration of the life cycle information about the cryptographic key by the registration control unit 122. For example, in a case where the registration of the life cycle information about the cryptographic key in the QKDN management apparatus 14 by the registration control unit 122 is not accepted, the monitoring unit 121 determines that the operation of the QKDN management apparatus 14 is stopped, while in a case where the registration of the life cycle information about the cryptographic key in the QKDN management apparatus 14 by the registration control unit 122 is accepted, the monitoring unit 121 determines that the operation of the QKDN management apparatus 14 is started.

Alternatively, the monitoring unit 121 may receive a notification that the operation is stopped sent from the QKDN management apparatus 14 or a notification that the operation is started sent from the QKDN management apparatus 14, and determine whether or not the QKDN management apparatus 14 is in operation based on the content of the notification.

In a case where the monitoring unit 121 determines that the operation of the QKDN management apparatus 14 is stopped, the registration control unit 122 stores in the storage unit 123 the encryption key before information indicating that the encryption key has been generated by the key generation apparatus 11 managed by the key management apparatus 12 is registered in the QKDN management apparatus 14 as the life cycle information. Then, in a case where the monitoring unit 121 determines that the operation of the QKDN management apparatus 14 is started, the registration control unit 122 registers in the QKDN management apparatus 14 the life cycle information about the cryptographic key before the registration stored in the storage unit 123.

Note that, in a case where the monitoring unit 121 determines that the operation of the QKDN management apparatus 14 is stopped, the registration control unit 122 may further store in the storage unit 123 the life cycle information about the cryptographic key before information indicating that the encryption key has been supplied to the application by the key supply apparatus 13 managed by the key management apparatus 12 is registered in the QKDN management apparatus 14 as the life cycle information. Even in this case, in a case where the monitoring unit 121 then determines that the operation of the QKDN management apparatus 14 is started, the registration control unit 122 registers the life cycle information about the cryptographic key before the registration stored in the storage unit 123 in the QKDN management apparatus 14.

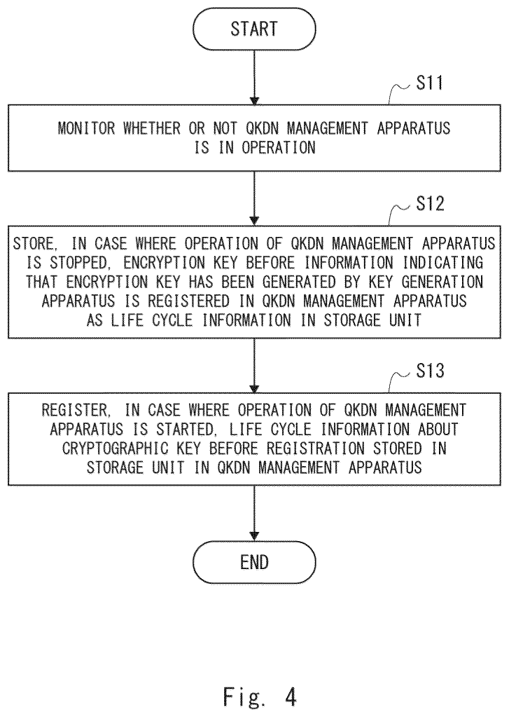

Next, operations performed by the key management apparatus 12 will be described with reference to FIG. 4. FIG. 4 is a flowchart showing the operations performed by the key management apparatus according to the present disclosure.

As shown in FIG. 4, the key management apparatus 12 first monitors whether or not the QKDN management apparatus 14 is in operation (Step S11). For example, the key management apparatus 12 periodically monitors whether or not the QKDN management apparatus 14 is in operation based on whether or not the QKDN management apparatus 14 responds to a periodic application for registration of life cycle information about the cryptographic key generated by the key generation apparatus 11 managed by the key management apparatus 12. For example, in a case where the registration of the life cycle information about the cryptographic key in the QKDN management apparatus 14 is not accepted, the key management apparatus 12 determines that the operation of the QKDN management apparatus 14 is stopped, while in a case where the registration of the life cycle information about the cryptographic key in the QKDN management apparatus 14 is accepted, the key management apparatus 12 determines that the operation of the QKDN management apparatus 14 is started.

Note that, in a case where the key management apparatus 12 determines that the operation of the QKDN management apparatus 14 is stopped, it stores in a storage unit the encryption key before information indicating that the encryption key has been generated by the key generation apparatus 11 managed by the key management apparatus 12 is registered in the QKDN management apparatus 14 as the life cycle information (Step S12).

Then, in a case where the key management apparatus 12 determines that the operation of the QKDN management apparatus 14 is started, it registers the life cycle information about the cryptographic key before the registration stored in the storage unit in the QKDN management apparatus 14 (Step S13).

As described above, the key management apparatus 12 according to the present disclosure stores a cryptographic key that is generated by the key generation apparatus 11 managed by the key management apparatus 12 in the storage unit in a case where the operation of the QKDN management apparatus 14 is stopped, and registers life cycle information about the cryptographic key before registration stored in the storage unit in the QKDN management apparatus 14 in a case where the operation of the QKDN management apparatus 14 is started. Thus, the key management apparatus 12 according to the present disclosure can, instead of having to discard the cryptographic key the life cycle information of which has not been registered in the QKDN management apparatus 14, re-register this cryptographic key and use it, and therefore the cryptographic key can be efficiently used.

### (Example of Operations Performed by the Quantum Key Distribution System 1)

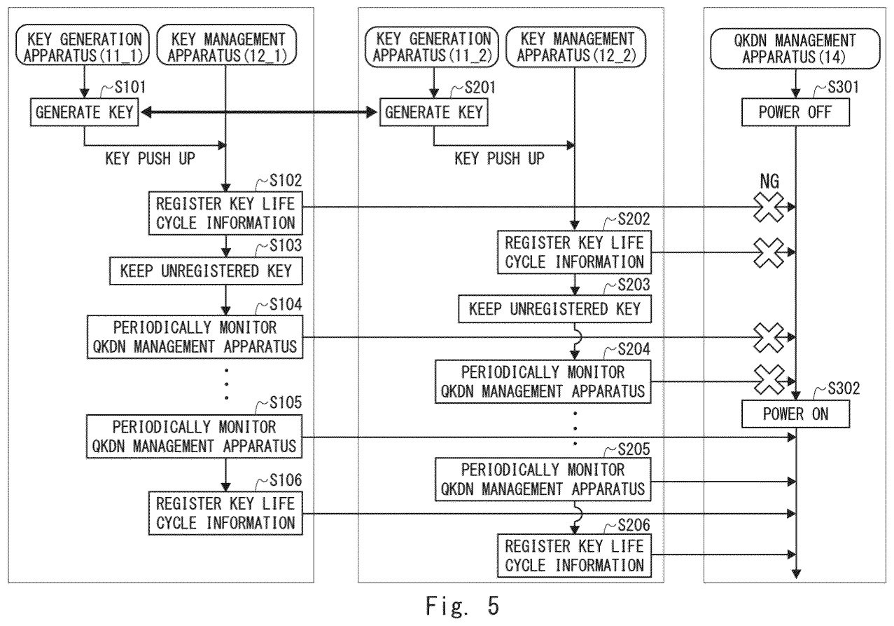

Next, an example of operations performed by the quantum key distribution system 1 will be described with reference to FIG. 5. FIG. 5 is a sequence diagram showing an example of operations performed by the quantum key distribution system according to the present disclosure. Note that, in the example of FIG. 5, of the plurality of key generation apparatuses 11, key generation apparatuses 11_1 and 11_2 that share a cryptographic key are shown, and of the plurality of key management apparatuses 12, key management apparatuses 12_1 and 12_2 that respectively manage the key generation apparatuses 11_1 and 11_2 are shown.

First, the key generation apparatuses 11_1 and 11_2 generate respective cryptographic keys that are the same as each other (Steps S101 and S102). Further, at this time, the QKDN management apparatus 14 stops its operation for reasons such as that a periodic inspection is to be performed (Step S301).

Then, the key management apparatus 12_1 attempts to register life cycle information about the cryptographic key generated by the key generation apparatus 11_1 in the QKDN management apparatus 14 (Step S102). However, the QKDN management apparatus 14 does not accept the registration of the life cycle information about the cryptographic key by the key management apparatus 12_1 since the operation of the QKDN management apparatus 14 is stopped.

In this case, the key management apparatus 12_1 stores, instead of having to discard the cryptographic key that has not been registered in the QKDN management apparatus 14, this cryptographic key in the storage unit (Step S103). Then, the key management apparatus 12_1 periodically monitors whether or not the QKDN management apparatus 14 is in operation (Steps S104 to S105). Further, in a case where the QKDN management apparatus 14 starts its operation (Step S302), the key management apparatus 12_1 registers the life cycle information about the cryptographic key stored in the storage unit in the QKDN management apparatus 14 (Step S106). Thus, the key management apparatus 12_1 can re-register, instead of having to discard the cryptographic key the life cycle information of which has not been registered in the QKDN management apparatus 14, this cryptographic key and use it, and therefore the cryptographic key can be efficiently used.

Similarly, the key management apparatus 12_2 attempts to register life cycle information about the cryptographic key generated by the key generation apparatus 11_2 in the QKDN management apparatus 14 (Step S202). However, the QKDN management apparatus 14 does not accept the registration of the life cycle information about the cryptographic key by the key management apparatus 12_2 since the operation of the QKDN management apparatus 14 is stopped.

In this case, the key management apparatus 12_2 stores, instead of having to discard the cryptographic key that has not been registered in the QKDN management apparatus 14, this cryptographic key in the storage unit (Step S203). Then, the key management apparatus 12_2 periodically monitors whether or not the QKDN management apparatus 14 is in operation (Steps S204 to S205). Further, in a case where the QKDN management apparatus 14 starts its operation (Step S302), the key management apparatus 12_2 registers the life cycle information about the cryptographic key stored in the storage unit in the QKDN management apparatus 14 (Step S206). Thus, the key management apparatus 12_2 can re-register, instead of having to discard the cryptographic key the life cycle information of which has not been registered in the QKDN management apparatus 14, this cryptographic key and use it, and therefore the cryptographic key can be efficiently used.

### (Another Example of Operations Performed by the Quantum Key Distribution System 1)

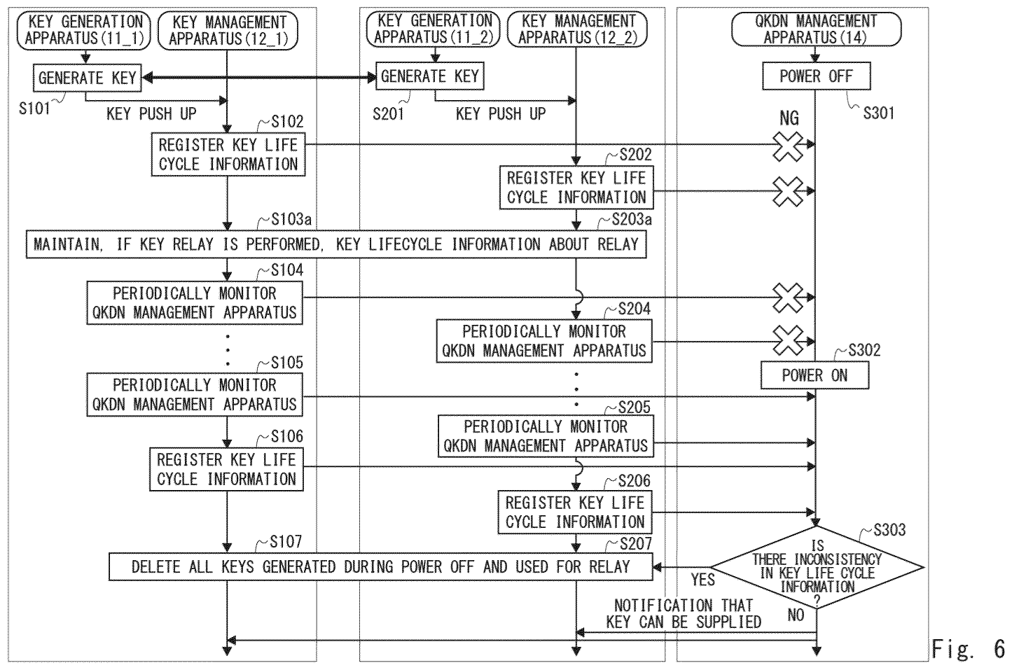

Next, another example of operations performed by the quantum key distribution system 1 will be described with reference to FIG. 6. FIG. 6 is a sequence diagram showing another example of operations performed by the quantum key distribution system according to the present disclosure. Note that, in the example of FIG. 6, of the plurality of key generation apparatuses 11, the key generation apparatuses 11_1 and 11_2 that share a cryptographic key are shown, and of the plurality of key management apparatuses 12, the key management apparatuses 12_1 and 12_2 that respectively manage the key generation apparatuses 11_1 and 11_2 are shown.

In the example of FIG. 6, a cryptographic key the life cycle information of which has not been registered is used as a cryptographic key for a key relay. Other processes shown in FIG. 6 are similar to those shown in FIG. 5.

First, the key generation apparatuses 11_1 and 11_2 generate respective cryptographic keys that are the same as each other (Steps S101 and S102). Further, at this time, the QKDN management apparatus 14 stops its operation for reasons such as that a periodic inspection is to be performed (Step S301).

Then, the key management apparatus 12_1 attempts to register life cycle information about the cryptographic key generated by the key generation apparatus 11_1 in the QKDN management apparatus 14 (Step S102). However, the QKDN management apparatus 14 does not accept the registration of the life cycle information about the cryptographic key by the key management apparatus 12_1 since the operation of the QKDN management apparatus 14 is stopped.

In this case, the key management apparatus 12_1 may use, instead of having to discard the cryptographic key that has not been registered in the QKDN management apparatus 14, this cryptographic key for purposes other than supplying it to an application; for example, the key management apparatus 12_1 may use it as a key (corresponding to the key Kab described above) delivered by a key relay. Alternatively, the key management apparatus 12_1 may use it as a cryptographic key (corresponding to the keys Kac, Kcb, etc. described above) that encrypts a key delivered by a key relay. Life cycle information indicating that the cryptographic key that has not been registered in the QKDN management apparatus 14 has been delivered by a key relay or used to encrypt a key delivered by a key relay is stored in the storage unit 123 (Step S103a). The life cycle information indicating that the cryptographic key has been delivered by a key relay or used to encrypt a key delivered by a key relay includes the time at which the cryptographic key was used, identification information of the key generation apparatus 11 that generated the cryptographic key, and the like.

Then, the key management apparatus 12_1 periodically monitors whether or not the QKDN management apparatus 14 is in operation (Steps S104 to S105). Further, in a case where the QKDN management apparatus 14 starts its operation (Step S302), the key management apparatus 12_1 registers the life cycle information stored in the storage unit, which information indicating that the cryptographic key has been delivered by a key relay or used to encrypt a key delivered by a key relay, in the QKDN management apparatus 14 (Step S106). Thus, the key management apparatus 12_1 can re-register, instead of having to discard the cryptographic key the life cycle information of which has not been registered in the QKDN management apparatus 14, this cryptographic key and use it, and therefore the cryptographic key can be efficiently used.

Similarly, the key management apparatus 12_2 attempts to register life cycle information about the cryptographic key generated by the key generation apparatus 11_2 in the QKDN management apparatus 14 (Step S202). However, the QKDN management apparatus 14 does not accept the registration of the life cycle information about the cryptographic key by the key management apparatus 12_2 since the operation of the QKDN management apparatus 14 is stopped.

In this case, the key management apparatus 12_2 may use, instead of having to discard the cryptographic key that has not been registered in the QKDN management apparatus 14, this cryptographic key for purposes other than supplying it to an application; for example, the key management apparatus 12_2 may use it as a key (corresponding to the key Kab described above) delivered by a key relay. Alternatively, the key management apparatus 12_2 may use it as a cryptographic key (corresponding to the keys Kac, Kcb, etc. described above) that encrypts a key delivered by a key relay. Life cycle information indicating that the cryptographic key that has not been registered in the QKDN management apparatus 14 has been delivered by a key relay or used to encrypt a key delivered by a key relay is stored in the storage unit 123 (Step S203a). The life cycle information indicating that the cryptographic key has been delivered by a key relay or used to encrypt a key delivered by a key relay includes the time at which the cryptographic key was used, identification information of the key generation apparatus 11 that generated the cryptographic key, and the like.

Then, the key management apparatus 12_2 periodically monitors whether or not the QKDN management apparatus 14 is in operation (Steps S204 to S205). Further, in a case where the QKDN management apparatus 14 starts its operation (Step S302), the key management apparatus 12_2 registers the life cycle information stored in the storage unit, which information indicating that the cryptographic key has been delivered by a key relay or used to encrypt a key delivered by a key relay, in the QKDN management apparatus 14 (Step S206). Thus, the key management apparatus 12_2 can re-register, instead of having to discard the cryptographic key the life cycle information of which has not been registered in the QKDN management apparatus 14, this cryptographic key and use it, and therefore the cryptographic key can be efficiently used.

However, in a case where the QKDN management apparatus 14 determines that there is an inconsistency in the cryptographic keys used for a key relay (YES in Step S301), the key management apparatuses 12_1 and 12_2 delete the cryptographic keys delivered by a key relay (Steps S107 and S207). On the other hand, in a case where the QKDN management apparatus 14 determines that there is no inconsistency in the cryptographic keys used for a key relay (NO in Step S301), the cryptographic keys delivered by a key relay become valid.

### (Another Example of Operations Performed by the Quantum Key Distribution System 1)

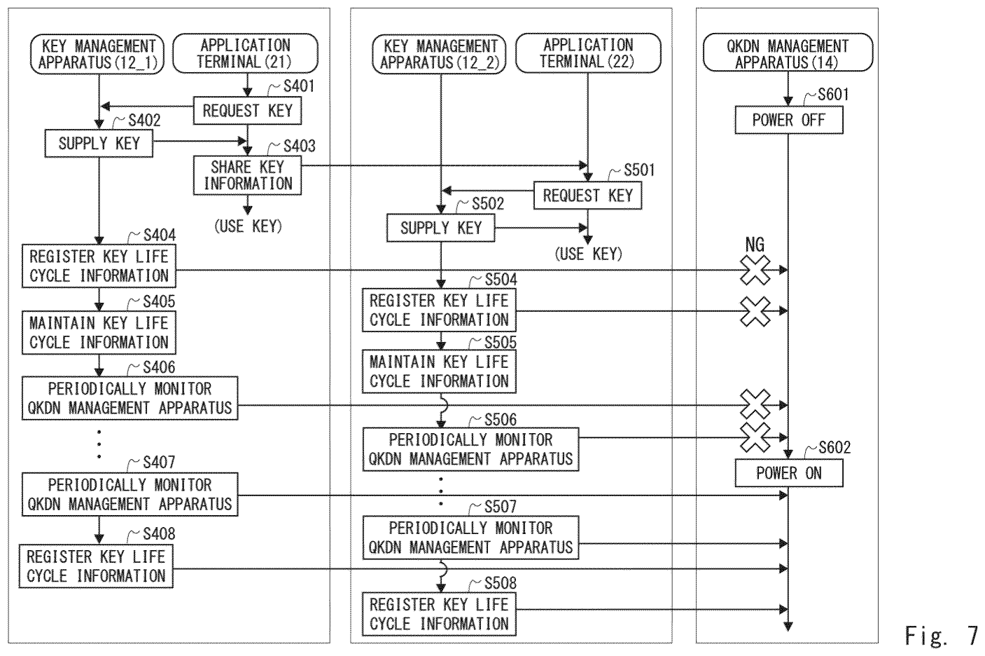

Next, another example of operations performed by the quantum key distribution system 1 will be described with reference to FIG. 7. FIG. 7 is a sequence diagram showing another example of operations performed by the quantum key distribution system according to the present disclosure. Note that, in the example of FIG. 7, of the plurality of key management apparatuses 12, the key management apparatuses 12_1 and 12_2 that share a cryptographic key are shown, and of a plurality of terminals of the application in which quantum cryptographic communication is performed, terminals 21 and 22 to which cryptographic keys are supplied by the key management apparatuses 12_1 and 12_2 are shown. Further, in the following description, the key supply apparatuses 13 corresponding to the key management apparatuses 12_1 and 12_2 are referred to as key supply apparatuses 13_1 and 13_2, respectively.

First, the terminal 21 requests a cryptographic key for performing quantum cryptographic communication with the terminal 22 from the key management apparatus 12_1 (Step S401). In response to this, the key management apparatus 12_1 supplies the cryptographic key to the terminal 21 by using the key supply apparatus 13_1 (Step S402). After the terminal 21 receives the cryptographic key, it requests the terminal 22 that performs quantum cryptographic communication to share key information (Step S403). In response to this, the terminal 22 requests a cryptographic key for performing quantum cryptographic communication with the terminal 21 from the key management apparatus 12_2 (Step S501). In response to this, the key management apparatus 12_2 supplies the cryptographic key to the terminal 22 by using the key supply apparatus 13_2 (Step S502).

Further, at this time, the QKDN management apparatus 14 stops its operation for reasons such as that a periodic inspection is to be performed (Step S601).

Note that, regarding the cryptographic key supplied to the terminal 21, life cycle information indicating that it has been generated by the key generation apparatus 11_1 has already been registered in the QKDN management apparatus 14. However, life cycle information indicating that it has been supplied to the terminal 21 by the key supply apparatus 13_1 has not been registered, and thus it needs to be registered. Similarly, regarding the cryptographic key supplied to the terminal 22, life cycle information indicating that it has been generated by the key generation apparatus 11_2 has already been registered in the QKDN management apparatus 14. However, life cycle information indicating that it has been supplied to the terminal 22 by the key supply apparatus 13_2 has not been registered, and thus it needs to be registered.

Therefore, the key management apparatus 12_1 attempts to register the life cycle information about the cryptographic key supplied to the terminal 21 by the key supply apparatus 13_1 in the QKDN management apparatus 14 (Step S404). However, the QKDN management apparatus 14 does not accept the registration of the life cycle information about the cryptographic key by the key management apparatus 12_1 since the operation of the QKDN management apparatus 14 is stopped.

In this case, the key management apparatus 12_1 stores the life cycle information about the cryptographic key supplied to the terminal 21 by the key supply apparatus 13_1 in the storage unit (Step S405). Then, the key management apparatus 12_1 periodically monitors whether or not the QKDN management apparatus 14 is in operation (Steps S406 to S407). Further, in a case where the QKDN management apparatus 14 starts its operation (Step S602), the key management apparatus 12_1 registers the life cycle information about the cryptographic key stored in the storage unit in the QKDN management apparatus 14 (Step S408). That is, the key management apparatus 12_1 can supply the cryptographic key registered in the QKDN management apparatus 14 to the terminal 21 of the application on the condition that, even in a case where the operation of the QKDN management apparatus 14 is stopped, the cryptographic key is re-registered after the operation of the QKDN management apparatus 14 is resumed. That is, the key management apparatus 12_1 can efficiently use the cryptographic key.

Similarly, the key management apparatus 12_2 attempts to register the life cycle information about the cryptographic key supplied to the terminal 22 by the key supply apparatus 13_2 in the QKDN management apparatus 14 (Step S504). However, the QKDN management apparatus 14 does not accept the registration of the life cycle information about the cryptographic key by the key management apparatus 12_2 since the operation of the QKDN management apparatus 14 is stopped.

In this case, the key management apparatus 12_2 stores the life cycle information about the cryptographic key supplied to the terminal 22 by the key supply apparatus 13_2 in the storage unit (Step S505). Then, the key management apparatus 12_2 periodically monitors whether or not the QKDN management apparatus 14 is in operation (Steps S506 to S507). Further, in a case where the QKDN management apparatus 14 starts its operation (Step S602), the key management apparatus 12_2 registers the life cycle information about the cryptographic key stored in the storage unit in the QKDN management apparatus 14 (Step S508). That is, the key management apparatus 12_2 can supply the cryptographic key registered in the QKDN management apparatus 14 to the terminal 22 of the application on the condition that, even in a case where the operation of the QKDN management apparatus 14 is stopped, the cryptographic key is re-registered after the operation of the QKDN management apparatus 14 is resumed. That is, the key management apparatus 12_2 can efficiently use the cryptographic key.

As described above, in the quantum key distribution system 1 according to the present disclosure, each of the key management apparatuses 12 stores a cryptographic key that is generated by the key generation apparatus 11 managed by the key management apparatus 12 in the storage unit in a case where the operation of the QKDN management apparatus 14 is stopped, and registers life cycle information about the cryptographic key before registration stored in the storage unit in the QKDN management apparatus 14 in a case where the operation of the QKDN management apparatus 14 is started. Thus, the key management apparatus 12 according to the present disclosure can re-register, instead of having to discard the cryptographic key the life cycle information of which has not been registered in the QKDN management apparatus 14, this cryptographic key and use it, and therefore the cryptographic key can be efficiently used.

### (Hardware Configuration for Implementing a Key Management Function of the Key Management Apparatus 12)

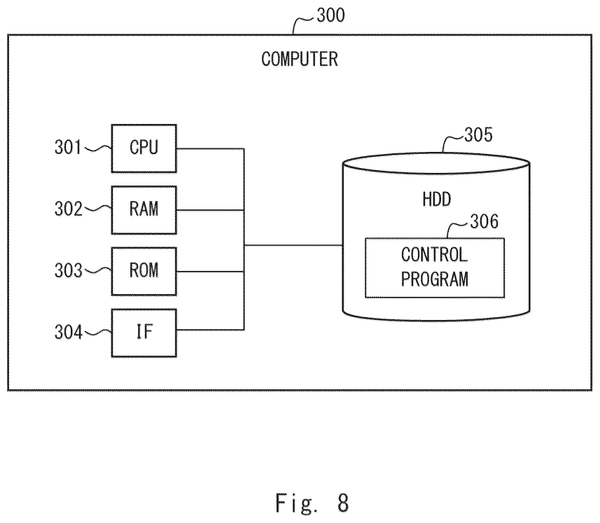

Key management processing implemented by the key management apparatus 12 can be implemented by a general-purpose computer system. A brief description thereof will be given below with reference to FIG. 8.

FIG. 8 is a block diagram showing an example of a hardware configuration for implementing a key management function of the key management apparatus 12. A computer 300 includes, for example, a Central Processing Unit (CPU) 301, which is a control apparatus, a Random Access Memory (RAM) 302, and a Read Only Memory (ROM) 303. The computer 300 further includes an Inter Face (IF) 304, which is an interface with the outside, and a Hard Disk Drive (HDD) 305, which is an example of a non-volatile storage device. Further, the computer 300 may include, as components that are not shown, input devices such as a keyboard and a mouse, and display devices such as a display.

The HDD 305 stores an Operating System (OS) (not shown) and a control program 306. The control program 306 is a computer program in which the key management processing performed by the key management apparatus 12 is implemented.

The CPU 301 controls, for example, various types of processing performed in the computer 300, access to the RAM 302, the ROM 303, the IF 304, and the HDD 305. In the computer 300, the CPU 301 reads the OS and the control program 306 stored in the HDD 305 and executes them. In this way, the computer 300 implements the key management function of the key management apparatus 12.

The above-described program includes instructions (or software codes) that, in a case where it is loaded into a computer, cause the computer to perform one or more of the functions described in the present disclosure. The program may be stored in a non-transitory computer readable medium or a tangible storage medium. By way of example, and not a limitation, non-transitory computer readable media or tangible storage media can include a RAM, a ROM, a flash memory, a solid-state drive (SSD) or other types of memory technologies, a CD-ROM, a digital versatile disc (DVD), a Blu-ray (registered trademark) disc or other types of optical disc storages, a magnetic cassette, a magnetic tape, and a magnetic disc storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A quantum key distribution system comprising:
a plurality of key generation apparatuses configured to generate cryptographic keys, the plurality of key generation apparatuses being respectively provided in a plurality of bases and connected to each other through optical fibers;
a plurality of key management apparatuses provided so as to respectively correspond to the plurality of key generation apparatuses, the plurality of key management apparatuses being configured to manage the cryptographic keys respectively generated by the plurality of key generation apparatuses;
a plurality of key supply apparatuses provided so as to respectively correspond to the plurality of key management apparatuses, the plurality of key supply apparatuses being configured to supply the cryptographic keys managed by the plurality of key management apparatuses to an application in which quantum cryptographic communication is performed; and
a QKDN management apparatus configured to acquire, as life cycle information, a cryptographic key processing status of each of the plurality of key generation apparatuses, the plurality of key management apparatuses, and the plurality of key supply apparatuses and manage the acquired statuses, wherein
each of the key management apparatuses comprises:
a storage unit;
a monitoring unit configured to monitor whether or not the QKDN management apparatus is in operation; and
a registration control unit configured to, in a case where the monitoring unit determines that an operation of the QKDN management apparatus is stopped, store in the storage unit the cryptographic key before information indicating that the cryptographic key has been generated by the key generation apparatus managed by the key management apparatus is registered in the QKDN management apparatus as the life cycle information, and in a case where the monitoring unit determines that an operation of the QKDN management apparatus is started, register in the QKDN management apparatus the life cycle information about the cryptographic key stored in the storage unit.

### (Supplementary Note 2)

The quantum key distribution system according to supplementary note 1, wherein
in each of the key management apparatuses,
in a case where the registration of the life cycle information about the cryptographic key in the QKDN management apparatus by the registration control unit is not accepted, the monitoring unit determines that the QKDN management apparatus is stopped.

### (Supplementary Note 3)

The quantum key distribution system according to supplementary note 2, wherein
in each of the key management apparatuses,
the monitoring unit periodically monitors whether or not the QKDN management apparatus is in operation based on a periodic application for registration of the life cycle information about the cryptographic key by the registration control unit.

### (Supplementary Note 4)

The quantum key distribution system according to supplementary note 1, wherein
in each of the key management apparatuses,
the monitoring unit determines whether or not the QKDN management apparatus is in operation based on one of a notification that the operation of the QKDN management apparatus is stopped sent from the QKDN management apparatus and a notification that the operation of the QKDN management apparatus is started sent from the QKDN management apparatus.

### (Supplementary Note 5)

The quantum key distribution system according to supplementary note 1, wherein
in each of the key management apparatuses,
in a case where the monitoring unit determines that an operation of the QKDN management apparatus is stopped, the registration control unit stores in the storage unit the life cycle information about the cryptographic key before information indicating that the encryption key has been supplied to the application by the key supply apparatus managed by the key management apparatus is registered in the QKDN management apparatus as the life cycle information, and in a case where the monitoring unit determines that an operation of the QKDN management apparatus is started, the registration control unit registers in the QKDN management apparatus the life cycle information about the cryptographic key stored in the storage unit.

### (Supplementary Note 6)

The quantum key distribution system according to supplementary note 1, wherein
in each of the key management apparatuses,
in a case where the monitoring unit determines that an operation of the QKDN management apparatus is stopped, the encryption key before information indicating that the encryption key has been generated by the key generation apparatus managed by the key management apparatus is registered in the QKDN management apparatus as the life cycle information is used as a key delivered by a key relay or a cryptographic key for encrypting a key delivered by a key relay.

### (Supplementary Note 7)

The quantum key distribution system according to supplementary note 6, wherein
in each of the key management apparatuses,
in a case where the monitoring unit determines that an operation of the QKDN management apparatus is started, the registration control unit registers in the QKDN management apparatus life cycle information indicating that the encryption key before information indicating that the encryption key has been generated by the key generation apparatus managed by the key management apparatus is registered in the QKDN management apparatus as the life cycle information has been delivered by a key relay or used to encrypt a key delivered by a key relay.

### (Supplementary Note 8)

The quantum key distribution system according to supplementary note 7, wherein in a case where the QKDN management apparatus determines that there is an inconsistency in the life cycle information about a cryptographic key which has been delivered by a key relay and for which registration has been applied for or a cryptographic key which has been used to encrypt a key delivered by a key relay and for which registration has been applied for, the QKDN management apparatus deletes the cryptographic key delivered by the key relay.

### (Supplementary Note 9)

A key management apparatus configured to manage a cryptographic key generated by a key generation apparatus connected to another key generation apparatus through an optical fiber, the key management apparatus comprising:
a storage unit;
a monitoring unit configured to monitor whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information; and
a registration control unit configured to, in a case where the monitoring unit determines that an operation of the QKDN management apparatus is stopped, store in the storage unit the cryptographic key before information indicating that the cryptographic key has been generated by the key generation apparatus managed by the key management apparatus is registered in the QKDN management apparatus as the life cycle information, and in a case where the monitoring unit determines that an operation of the QKDN management apparatus is started, register in the QKDN management apparatus the life cycle information about the cryptographic key stored in the storage unit.

### (Supplementary Note 10)

A key management method for a key management apparatus configured to manage a cryptographic key generated by a key generation apparatus connected to another key generation apparatus through an optical fiber, the key management method comprising:
monitoring whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information;
in a case where it is determined that an operation of the QKDN management apparatus is stopped, storing in a storage unit the cryptographic key before information indicating that the cryptographic key has been generated by the key generation apparatus managed by the key management apparatus is registered in the QKDN management apparatus as the life cycle information; and
in a case where it is determined that an operation of the QKDN management apparatus is started, registering in the QKDN management apparatus the life cycle information about the cryptographic key stored in the storage unit.

### (Supplementary Note 11)

A control program for causing a computer to execute key management processing performed by a key management apparatus configured to manage a cryptographic key generated by a key generation apparatus connected to another key generation apparatus through an optical fiber, the key management processing comprising:
monitoring whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information;
in a case where it is determined that an operation of the QKDN management apparatus is stopped, storing in a storage unit the cryptographic key before information indicating that the cryptographic key has been generated by the key generation apparatus managed by the key management apparatus is registered in the QKDN management apparatus as the life cycle information; and
in a case where it is determined that an operation of the QKDN management apparatus is started, registering in the QKDN management apparatus the life cycle information about the cryptographic key stored in the storage unit.

Some or all of elements (e.g., structures and functions) specified in supplementary notes 2 to 8 dependent on supplementary note 1 may also be dependent on supplementary notes 9 to 11 in dependency similar to that of supplementary notes 2 to 8 on supplementary note 1. Some or all of elements specified in any of supplementary notes may be applied to various types of hardware, software, and recording means for recording software, systems, and methods.

The present disclosure can provide a quantum key distribution system, a key management apparatus, a key management method, and a control program by which cryptographic keys can be efficiently used.

What is claimed is:

1. A quantum key distribution system comprising:
a plurality of key generation apparatuses configured to generate cryptographic keys, the plurality of key generation apparatuses being respectively provided in a plurality of bases and connected to each other through optical fibers;
a plurality of key management apparatuses provided so as to respectively correspond to the plurality of key generation apparatuses, the plurality of key management apparatuses being configured to manage the cryptographic keys respectively generated by the plurality of key generation apparatuses;
a plurality of key supply apparatuses provided so as to respectively correspond to the plurality of key management apparatuses, the plurality of key supply apparatuses being configured to supply the cryptographic keys managed by the plurality of key management apparatuses to an application in which quantum cryptographic communication is performed; and
a QKDN management apparatus configured to acquire, as life cycle information, a cryptographic key processing status of each of the plurality of key generation apparatuses, the plurality of key management apparatuses, and the plurality of key supply apparatuses and manage the acquired statuses, wherein
each of the key management apparatuses comprises:
at least one memory; and
at least one processor coupled to the at least one memory, the at least one processor being configured to:
monitor whether or not the QKDN management apparatus is in operation; and
in a case where it is determined that an operation of the QKDN management apparatus is stopped, store the cryptographic key before information indicating that the cryptographic key has been generated by the key generation apparatus managed by the key management apparatus is registered in the QKDN management apparatus as the life cycle information, and in a case where it is determined that an operation of the QKDN management apparatus is started, register the life cycle information about the stored cryptographic key in the QKDN management apparatus.

2. The quantum key distribution system according to claim 1, wherein
in each of the key management apparatuses,
in the monitoring of whether or not the QKDN management apparatus is in operation, in a case where the registration of the life cycle information about the stored cryptographic key in the QKDN management apparatus is not accepted, the at least one processor determines that the QKDN management apparatus is stopped.

3. The quantum key distribution system according to claim 2, wherein
in each of the key management apparatuses,
in the monitoring of whether or not the QKDN management apparatus is in operation, the at least one processor periodically monitors whether or not the QKDN management apparatus is in operation based on a periodic application for registration of the life cycle information about the stored cryptographic key.

4. The quantum key distribution system according to claim 1, wherein
in each of the key management apparatuses,
in the monitoring of whether or not the QKDN management apparatus is in operation, the at least one processor determines whether or not the QKDN management apparatus is in operation based on one of a notification that the operation of the QKDN management apparatus is stopped sent from the QKDN management apparatus and a notification that the operation of the QKDN management apparatus is started sent from the QKDN management apparatus.

5. The quantum key distribution system according to claim 1, wherein
in each of the key management apparatuses,
in a case where it is determined that an operation of the QKDN management apparatus is stopped, the at least one processor stores the life cycle information about the cryptographic key before information indicating that the encryption key has been supplied to the application by the key supply apparatus managed by the key management apparatus is registered in the QKDN management apparatus as the life cycle information, and in a case where it is determined that an operation of the QKDN management apparatus is started, the at least one processor registers the stored life cycle information about the cryptographic key in the QKDN management apparatus.

6. The quantum key distribution system according to claim 1, wherein
in each of the key management apparatuses,
in a case where it is determined that an operation of the QKDN management apparatus is stopped, the at least one processor uses, as a key delivered by a key relay or a cryptographic key for encrypting a key delivered by a key relay, the encryption key before information indicating that the encryption key has been generated by the key generation apparatus managed by the key management apparatus is registered in the QKDN management apparatus as the life cycle information.

7. The quantum key distribution system according to claim 6, wherein
in each of the key management apparatuses,
in a case where it is determined that an operation of the QKDN management apparatus is started, the at least one processor registers in the QKDN management apparatus life cycle information indicating that the encryption key before information indicating that the encryption key has been generated by the key generation apparatus managed by the key management apparatus is registered in the QKDN management apparatus as the life cycle information has been delivered by a key relay or used to encrypt a key delivered by a key relay.

8. The quantum key distribution system according to claim 7, wherein in a case where the QKDN management apparatus determines that there is an inconsistency in the life cycle information about a cryptographic key which has been delivered by a key relay and for which registration has been applied for or a cryptographic key which has been used to encrypt a key delivered by a key relay and for which registration has been applied for, the QKDN management apparatus deletes the cryptographic key delivered by the key relay.

9. A key management apparatus configured to manage a cryptographic key generated by a key generation apparatus connected to another key generation apparatus through an optical fiber, the key management apparatus comprising:
at least one memory; and
at least one processor coupled to the at least one memory, wherein
the at least one processor is configured to:
monitor whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information; and
in a case where it is determined that an operation of the QKDN management apparatus is stopped, store the cryptographic key before information indicating that the cryptographic key has been generated by the key generation apparatus managed by the key management apparatus is registered in the QKDN management apparatus as the life cycle information, and in a case where it is determined that an operation of the QKDN management apparatus is started, register the life cycle information about the stored cryptographic key in the QKDN management apparatus.

10. A key management method for a key management apparatus configured to manage a cryptographic key generated by a key generation apparatus connected to another key generation apparatus through an optical fiber, the key management method comprising:
monitoring whether or not a QKDN management apparatus is in operation, the QKDN management apparatus being configured to acquire information indicating that a cryptographic key is generated by each of a plurality of key generation apparatuses as life cycle information of each of the cryptographic keys and manage the acquired information;
in a case where it is determined that an operation of the QKDN management apparatus is stopped, storing in a storage unit the cryptographic key before information indicating that the cryptographic key has been generated by the key generation apparatus managed by the key management apparatus is registered in the QKDN management apparatus as the life cycle information; and
in a case where it is determined that an operation of the QKDN management apparatus is started, registering in the QKDN management apparatus the life cycle information about the cryptographic key stored in the storage unit.

11. The key management method according to claim 10, wherein in the monitoring of whether or not the QKDN management apparatus is in operation, in a case where the registration of the life cycle information about the cryptographic key stored in the storage unit in the QKDN management apparatus is not accepted, it is determined that the QKDN management apparatus is stopped.

12. The key management method according to claim 11, wherein in the monitoring of whether or not the QKDN management apparatus is in operation, whether or not the QKDN management apparatus is in operation is periodically monitored based on a periodic application for registration of the life cycle information about the cryptographic key stored in the storage unit.

13. The key management method according to claim 10, wherein in the monitoring of whether or not the QKDN management apparatus is in operation, it is determined whether or not the QKDN management apparatus is in operation based on one of a notification that the operation of the QKDN management apparatus is stopped sent from the QKDN management apparatus and a notification that the operation of the QKDN management apparatus is started sent from the QKDN management apparatus.

14. The key management method according to claim 10, wherein
in a case where it is determined that an operation of the QKDN management apparatus is stopped, the life cycle information about the cryptographic key before information indicating that the encryption key has been supplied to the application by the key supply apparatus managed by the key management apparatus is registered in the QKDN management apparatus as the life cycle information is stored in the storage unit, and
in a case where it is determined that an operation of the QKDN management apparatus is started, the stored life cycle information about the cryptographic key is registered in the QKDN management apparatus.

15. The key management method according to claim 10, wherein in a case where it is determined that an operation of the QKDN management apparatus is stopped, the encryption key before information indicating that the encryption key has been generated by the key generation apparatus managed by the key management apparatus is registered in the QKDN management apparatus as the life cycle information is used as a key delivered by a key relay or a cryptographic key for encrypting a key delivered by a key relay.

16. The key management method according to claim 15, wherein in a case where it is determined that an operation of the QKDN management apparatus is started, life cycle information indicating that the encryption key before information indicating that the encryption key has been generated by the key generation apparatus managed by the key management apparatus is registered in the QKDN management apparatus as the life cycle information has been delivered by a key relay or used to encrypt a key delivered by a key relay is registered in the QKDN management apparatus.

17. The key management method according to claim 16, wherein in a case where the QKDN management apparatus determines that there is an inconsistency in the life cycle information about a cryptographic key which has been delivered by a key relay and for which registration has been applied for or a cryptographic key which has been used to encrypt a key delivered by a key relay and for which registration has been applied for, the QKDN management apparatus deletes the cryptographic key delivered by the key relay.
